(19) United States
(12) Patent Application Publication
(10) Pub. No.: US 2013/0056994 A1
(43) Pub. Date: Mar. 7, 2013

(54) DOOR BODY UNLATCHING DEVICE FOR VEHICLE

(71) Applicant: Tetsuya SAGO, Miyagi-ken (JP)

(72) Inventor: Tetsuya SAGO, Miyagi-ken (JP)

(73) Assignee: Alps Electric Co., Ltd., Ota-ku (JP)

(21) Appl. No.: 13/561,810

(22) Filed: Jul. 30, 2012

(30) Foreign Application Priority Data
Sep. 7, 2011 (JP) 2011-195106

(51) Int. Cl. E05C 19/12; E05C 19/02

(52) U.S. Cl. 292/101

(57) ABSTRACT

A unlatching device includes: a pair of human approach sensors disposed at both side ends of, for example, a rear glass; a retractable handle retractably received at a door body, such as a rear door; a cam member pivotally supported by the door body; a manual unlatching lever for manually unlatching a latch mechanism; and a solenoid capable of driving a stopper member of the latch mechanism, in which, when a predetermined signal is output from the human approach sensor, the stopper member is pressed by the solenoid and is moved away from an engaging/disengaging member, and the engaging/disengaging member is made to pivot by urging force and is released from a stopper, whereby the door body is unlatched and the retractable handle projects rearward from the door body.

### CLAIM OF PRIORITY

This application contains subject matter related to and claims the benefit of the Japanese Patent Application No. 2011-195106 filed on Sep. 7, 2011, the entire contents of which is incorporated herein by reference.

### BACKGROUND OF THE DISCLOSURE

1. Field of the Disclosure

The present disclosure relates to a door body unlatching device for a vehicle. The door body unlatching device unlatches a latch mechanism latching a rear door and a trunk lid (hereinafter, collectively referred to as “door body”) provided at a vehicle rear end to enable the door body to open.

2. Description of the Related Art

A rear door provided at a rear end of a van and a trunk lid provided at a rear end of a sedan are door bodies which are locked by a latch mechanism. A user needs to unlatch the latch mechanism to open the door body. In a typical unlatching operation of a rear door which opens upward and a latch mechanism of a trunk lid, a user operates a lever-shaped manual unlatching member provided at a lower portion of the vehicle rear end to unlatch the latch mechanism, and then raises a door body (i.e., a rear door or a trunk lid) while grasping the manual unlatching member so that the door body pivots about a hinge and opens.

A portion exposed below the vehicle rear end easily becomes dirty with muddy water and so forth splashed against rear wheels during the travelling of the vehicle. In order to prevent the appearance from being impaired by muddy water and so forth adhering to a lower portion of the rear door, there have been proposed such solutions as providing a mud guard between a rear door and rear wheels, and disposing an extension of a lower rear panel between a rear door and rear wheels (see, for example, Japanese Unexamined Patent Application Publication No. 11-227636).

A manual unlatching member provided at a vehicle rear end for unlatching and opening a rear door which opens upward and a trunk lid is disposed at, for example, a hollow in a lower portion of the door body. Such a manual unlatching member easily becomes dirty with muddy water and so forth splashed against rear wheels during the travelling of the vehicle as described above. It is possible to reduce such dirt by a mud guard or a lower rear panel described above, but it is not avoidable that manual unlatching member becomes dirty after the vehicle travelled a bad road and so forth. Therefore, when the user grasps the manual unlatching member to open the door body of the vehicle rear end, dirt on the manual unlatching member may be transferred to the fingers and the palm of the user. In that case, the user may touch clothes and food without noticing that the fingers have become dirty with mud and so forth, whereby damage may be extended. If it is obvious that the manual unlatching member is severely dirty after the vehicle travelled on, for example, a bad road, the user needs to perform a bothering operation, such as removing the dirt on the manual unlatching member before opening the door body.

These and other drawbacks exist.

### SUMMARY OF THE DISCLOSURE

The present disclosure provides a door body unlatching device for a vehicle which enables a user to unlatch and open a door body (i.e., a rear door or a trunk lid) without letting the fingers become dirty.

The door body unlatching device according to the present disclosure is a door body unlatching device for a vehicle which includes, in a vehicle rear end at which a door body, including a rear door or a trunk lid, is capable of being latched by a latch mechanism: a human approach sensor configured to detect approaching of a human body; a retractable handle configured to be capable of being received in the door body and projecting rearward; and a driving means configured to be capable of applying driving force to the latch mechanism and the retractable handle, wherein, when a predetermined signal is output from the human approach sensor, the driving means makes the latch mechanism enter an unlatched state, and makes the retractable handle project rearward of the door body.

In the door body unlatching device according to the present disclosure, when the user lets the human approach sensor detect a part of a human body, such as a palm, in a non-contact manner and a predetermined signal is output from the sensor, driving force of the driving means is applied to the latch mechanism and the retractable handle. Then, the door body (i.e., the rear door or the trunk lid) of the vehicle rear end is unlatched and the retractable handle projects rearward. Since the retractable handle is received in the door body until then, there is no possibility of becoming dirty. This allows the user to open the door body by, for example, hooking the fingers on the retractable handle. This allows the user to unlatch the door body in a non-contact manner and open the same without letting the fingers become dirty, especially when there is a possibility that the manual unlatching member provided at a lower portion of the vehicle rear end for manually unlatching the door body. Another configuration may be implemented in which the manual unlatching member is excluded from the vehicle rear end.

Although the number of the human approach sensors is not particularly limited in the door body unlatching device described above, the various embodiments provide a configuration in which the human approach sensors are disposed at both right and left sides of the vehicle rear end and the driving means drives the latch mechanism and the retractable handle in accordance with detection signals output from these two human approach sensors. In this configuration, the door body is not unlatched by only placing the human body close to either one of the human approach sensors, and thus unintentional unlatching of the door body is less likely to occur. That is, it is highly probable that a human body is unintentionally placed close to either of the human approach sensors of a parked vehicle even if the person does not intend to unlatch the door body. However, it is less probable that a simultaneous or continuous placement of a human body close to both the right and left human approach sensors accidentally, a misoperation of the door body unlatching device is less likely to occur.

In this case, if the driving means is configured to drive the latch mechanism and the retractable handle in accordance with detection signals output a plurality of times from one of the two human approach sensors and detection signals output once from the other, a possibility that a predetermined signal is accidentally output from the human approach sensor is very low. Therefore, unintentional unlatching of the door body is even less likely to occur.

Detection systems of the human approach sensor in the door body unlatching device are not particularly limited. A capacitance sensor which detects approaching of a human body in accordance with a change in capacitance value is especially preferable from the viewpoint of high performance in detecting approaching of a human body in a non-contact manner, low cost, lightweight and flatness.

Therefore, there is no possibility that the use's fingers become dirty during an opening operation of the door body even after, for example, the vehicle travelled a bad road. Thus, usability of the door body is improved.

### BRIEF DESCRIPTION OF THE DRAWINGS

FIG. 1 is a schematic configuration diagram of a door body unlatching device according to an exemplary embodiment of the present disclosure;

FIG. 2 is an explanatory view of an operation of the door body unlatching device illustrated in FIG. 1;

FIG. 3 is an external view of an example in which the door body unlatching device illustrated in FIG. 1 is disposed at a rear door of a van;

FIG. 4 is an external view of an example in which the door body unlatching device illustrated in FIG. 1 is disposed at a trunk lid of a sedan;

FIG. 5 is a schematic configuration diagram of a door body unlatching device according to an exemplary embodiment of the present disclosure; and

FIG. 6 is an explanatory view of an operation of the door body unlatching device illustrated in FIG. 5.

### DETAILED DESCRIPTION OF THE DISCLOSURE

The following description is intended to convey a thorough understanding of the embodiments described by providing a number of specific embodiments and details involving an door body unlatching device. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

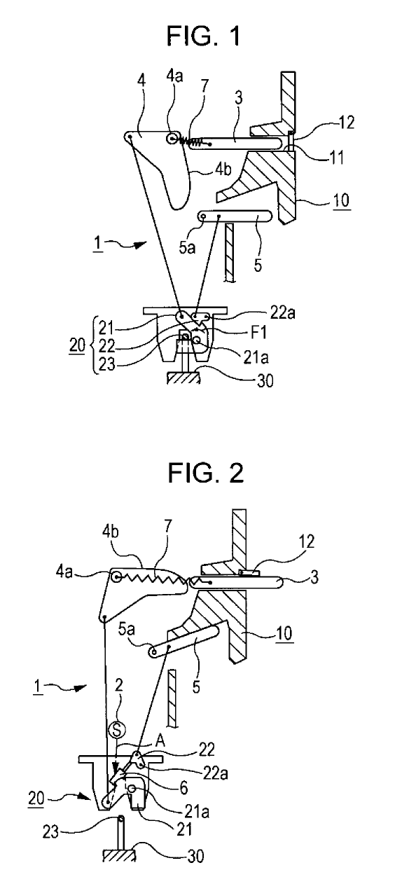

Hereinafter, embodiments of the present disclosure will be described with reference to the drawings. First, a door body unlatching device according to an exemplary embodiment of the present disclosure will be described with reference to FIGS. 1 to 4.

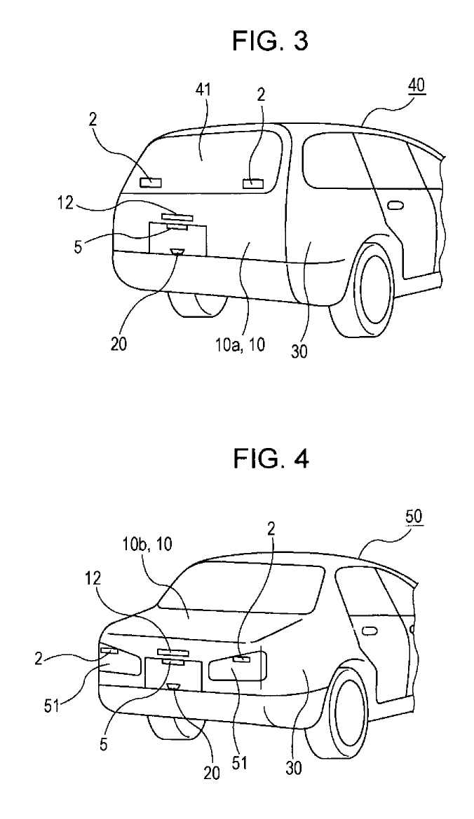

A door body unlatching device 1 according to an embodiment may be configured to unlatch a latch mechanism 20 which may latch a door body 10 (i.e., a rear door 10a or a trunk lid 10b) provided at a vehicle rear end, and to enable the door body 10 to open. As illustrated in FIG. 3, a rear door 10a as a door body 10 may be provided at a rear end of a van 40. As illustrated in FIG. 4, a trunk lid 10b as a door body 10 may be provided at a rear end of a sedan 50. The door body 10 may be hinged at an upper end of the body panel 30 and may be capable of pivoting upward and downward.

This door body unlatching device 1 may include a pair of human approach sensors 2 and 2, a retractable handle 3, a cam member 4, a manual unlatching lever 5 and a solenoid 6. The pair of human approach sensors 2 may detect approaching of a human body. The retractable handle 3 may be retractably received inside the door body 10 and may be capable of projecting rearward. The cam member 4 may be pivotally supported by the door body 10. The manual unlatching lever 5 may be configured to manually unlatch the latch mechanism 20. The solenoid 6 may be capable of driving a stopper member 22 of the latch mechanism 20 which will be described later. The cam member 4 may be pivotable about a pivot axis 4a. The manual unlatching lever 5 may be pivotable about a pivot axis 5a. The cam member 4 may include a cam surface 4b which may be brought into contact with a rear end of the retractable handle 3. A coil spring 7 may be disposed between the pivot axis 4a of the cam member 4 and the retractable handle 3.

The pair of human approach sensors 2 may be disposed at the right and left side ends of a rear glass 41 of the van 40 as illustrated in FIG. 3 or at right and left rear combination lamps 51 and 51 of a sedan 50 as illustrated in FIG. 4. The pair of right and left human approach sensors 2 may be a pair of capacitance sensors which may detect approaching of a human body in accordance with a change in capacitance value. In the present embodiment, an ON signal A (see FIG. 2) energizes the solenoid 6 and a plunger may jump out in accordance with detection signals output twice from one of the two human approach sensors 2 and 2 and a detection signal output once from the other of the two human approach sensors 2 and 2.

The latch mechanism 20 may include an engaging/disengaging member 21 which may be pivotable about a pivot axis 21a, a stopper member 22 pivotable about a pivot axis 22a, and a stopper 23 fixed to a lower end of a body panel 30. The engaging/disengaging member 21 may be urged by urging force F1 of an unillustrated spring member toward the arrow direction of FIG. 1. However, pivoting of the engaging/disengaging member 21 in that direction may be restrained by the stopper member 22 which may be in contact with a part of the engaging/disengaging member 21. When the stopper member 22 restrains the pivoting of the engaging/disengaging member 21, the engaging/disengaging member 21 may be in engagement with the stopper 23 on the side of the vehicle body. Thus, the door body 10 is in a latched state in which opening thereof is not possible (see FIG. 1). When the restraint of pivoting of the engaging/disengaging member 21 by the stopper member 22 is removed, the engaging/disengaging member 21 may be made to pivot by the urging force F1. When the engaging/disengaging member 21 pivots to reach a position out of the restraint by the stopper 23, the door body 10 may be in its unlatched state (see FIG. 2) which can be opened upward in the illustration of FIG. 1.

A relationship between the door body unlatching device 1 and the latch mechanism 20 may be as follows: the cam member 4 may be wired to the engaging/disengaging member 21, and the manual unlatching lever 5 may be wired to the stopper member 22. When a user grasps and raises the manual unlatching lever 5, the stopper member 22 may pivot clockwise in the illustration of FIG. 1 about the pivot axis 22a to move away from the engaging/disengaging member 21. Then, the engaging/disengaging member 21 may pivot counterclockwise in the illustration of FIG. 1 by the urging force F1. Then, since the engaging/disengaging member 21 is no longer restrained by the fixing by stopper 23, the door body 10 may enter an unlatched state, and the user may open the door body 10 while still grasping the manual unlatching lever 5. When the engaging/disengaging member 21 is in the state illustrated FIG. 1 pivots to a position illustrated in FIG. 2, the cam member 4 pivots relative to the pivoting of the engaging/disengaging member 21. This operation will be described later.

As described above, when an ON signal A energizes the solenoid 6 in accordance with detection signals output from the pair of human approach sensors 2, the plunger of the solenoid 6 may jump out and apply pressure to drive the stopper member 22 of the latch mechanism 20. The stopper member 22 may pivot clockwise in the illustration of FIG. 1 about the pivot axis 22a to move away from the engaging/disengaging member 21. Then, in the same manner as the user operates manual unlatching lever 5, the engaging/disengaging member 21 may pivot by the urging force F1 to move out of the restraint by the stopper 23 and the door body 10 may be unlatched. The cam member 4 may pivot counterclockwise in the illustration of FIG. 1 about the pivot axis 4a relative to the pivoting of the engaging/disengaging member 21. Then, the retractable handle 3 may be pressed against the cam surface 4b of the cam member 4 and may be made to project outward (i.e., rearward) through a slit 11 of the door body 10. In this process, a lid member 12 covering the slit 11 may be pushed upward by the retractable handle 3, and the coil spring 7 may be stretched as the retractable handle 3 projects outward. This allows the user to open the door body 10 by hooking the fingers on the projected retractable handle 3. The lid member 12 may be attached so as not to disturb the forward and backward movement of the retractable handle 3. When the retractable handle 3 is drawn inward (i.e., frontward) through the slit 11, the lid member 12 may restore to its closing position illustrated in FIG. 1 by the self weight.

Next, an operation of the door body unlatching device 1 will be described in detail. In this example, the user needs to unlatch to open the door body 10. The door body 10 may be unlatched by manually operating the manual unlatching lever 5, or may be latched in a non-contact manner using the human approach sensors 2. After the vehicle travelled on, for example, a bad road, it is highly probable that dirt, such as muddy water, adheres to the manual unlatching lever 5. If the user tries to manually operate the muddy manual unlatching lever 5 to open the door body 10, fingers of the user may become dirty. In such a case, the user may unlatch the door body 10 in a non-contact manner by placing a part of the body (e.g., a palm) close to the pair of right and left human approach sensors 2 provided at the vehicle rear end.

In particular, when the user places the fingers close to one of the two human approach sensors 2, then places the fingers close to the other of the two human approach sensors 2 and, thereafter, places the fingers close to the one of the two human approach sensors 2 again, an ON signal A (see FIG. 1) may energize the solenoid 6 and lets the plunger jump out and apply pressure to drive the stopper member 22 of the latch mechanism 20 so that the stopper member 22 moves apart from the engaging/disengaging member 21. Therefore, the engaging/disengaging member 21 may pivot by the urging force F1 to move out of the restraint by the stopper 23. With this operation, the door body 10 may be unlatched and the cam member 4 may pivot relative to the engaging/disengaging member 21. Then, the retractable handle 3 received inside the door body 10 may project rearward (see FIG. 2). The user may open the door body 10 easily by hooking the fingers on the retractable handle 3, which is not dirty.

When it is clear that manual unlatching lever 5 is not dirty, user may do manual operation of the manual unlatching lever 5, and may unlatch door body 10. In particular, when the user grasps the manual unlatching lever 5 and raises it to the position of FIG. 2, the stopper member 22 may pivot to move apart from the engaging/disengaging member 21 and the engaging/disengaging member 21 by the urging force F1 pivots out of the restraint by the stopper 23, whereby the door body 10 is unlatched. Therefore, the user may open the door body 10 while grasping the manual unlatching lever 5, which is not dirty.

When the door body 10 is closed, the engaging/disengaging member 21 which moves downward together with the door body 10 may be made to abut the stopper 23 and then driven to pivot clockwise in the illustration of FIG. 2. The engaging/disengaging member 21 may be made to engage the stopper member 22 without any particular operation, the door body 10 restores to the state of FIG. 1.

As described above, in the door body unlatching device 1 according to the present embodiment, when the user lets the human approach sensors 2 detect a part of the body, such as a palm, in a non-contact manner and a predetermined signal is output from both the sensors 2, the stopper member 22 may be driven by the solenoid 6 and may be moved away from engaging/disengaging member 21; therefore, the engaging/disengaging member 21 may pivot by the urging force F1 out of the restraint by the stopper 23, whereby the door body 10 (i.e., the rear door 10a and the trunk lid 10b) provided at the vehicle rear end may be unlatched and the retractable handle 3 projects rearward of the door body 10. The user may unlatch the door body 10 and make the retractable handle 3 be exposed by placing the fingers, for example, close to the human approach sensors 2. This allows the user, especially when there is a possibility that the manual unlatching lever 5 is dirty (e.g., after the travel on a bad road), to open the door body 10 easily without letting the fingers become dirty, by hooking the fingers on the retractable handle 3 which is received in the door body 10 and thus is not dirty. The door body unlatching device 1 may have another configuration in which the manual unlatching lever 5 is excluded from the vehicle rear end.

In the door body unlatching device 1, one of the human approach sensors 2 may be disposed at the right side and the other may be disposed at the left side of the vehicle rear end, and the solenoid 6 drives the stopper member 22 only when a predetermined signal is output from these two human approach sensors 2 and 2. The door body 10 may not be unlatched only when the human body is placed close to either one of the human approach sensors 2 and 2. It is highly probable that a human body is unintentionally placed close to either of the sensors 2, such as in a case in which a person who does not intend to unlatch the door body 10 comes close to the vehicle rear end when the vehicle is parked. However, it is less probable that a simultaneous or continuous placement of a human body close to both the right and left human approach sensors 2 accidentally, a misoperation of unintentional unlatching of the door body 10 is less likely to occur.

A predetermined signal to instruct unlatching of the door body 10 and projection of the retractable handle 3 may be set arbitrarily as long as the possibility thereof of being output accidentally from the human approach sensors 2 and 2 is low. It is, however, not required that the user perform a complex movement when approaching both the sensors 2. The exemplary embodiment described above is configured such that the solenoid 6 may drive the stopper member 22 in accordance with both the detection signals output twice from one side of the two human approach sensors 2 and a detection signal output once from the other of the two human approach sensors 2. Therefore, the possibility that the predetermined signal is accidentally output from the human approach sensor is very low and the user may approach both the human approach sensors 2 and 2 in a simple manner, whereby high operability is provided.

Detection systems of the human approach sensor 2 are not particularly limited. A capacitance sensor which detects approaching of a human body in accordance with a change in capacitance value as used in one of the above-described embodiments provides high performance in detecting approaching of a human body in a non-contact manner, low cost, lightweight and flatness.

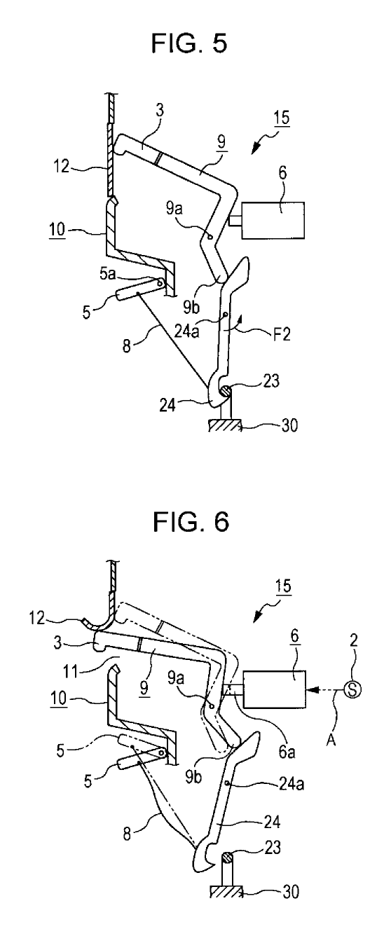

Next, a door body unlatching device according to an exemplary embodiment of the present disclosure will be described with reference to FIGS. 5 and 6. Corresponding components are denoted by the same reference numerals in FIGS. 5 and 6 as those in FIGS. 1 to 4 and duplicate description thereof is omitted.

A door body unlatching device 15 according to an exemplary embodiment may include: an unillustrated pair of human approach sensors disposed at both side ends of, for example, a rear glass; a retractable handle 3 which may be received inside a door body (i.e., a rear door or a trunk lid) 10 and may be capable of projecting rearward; an operating member 9 which may be capable of pivoting about a pivot axis 9a inside the door body 10 and which integrally may include the retractable handle 3 at a rear end thereof; a solenoid 6 which may drive the operating member 9 to pivot; and a manual unlatching lever 5 used to manually unlatch a latch mechanism 20. In the door body unlatching device 15, when a predetermined signal is output from the pair of human approach sensors, an ON signal A energize the solenoid 6, a plunger 6a may jump out and apply pressure to drive the operating member 9.

The latch mechanism 20 may include a stopper 23 and an engaging/disengaging member 24. The stopper 23 may be fixed to a lower end of a body panel 30. The engaging/disengaging member 24 may be capable of pivoting about a pivot axis 24a to engage/disengage the stopper 23. The engaging/disengaging member 24 may be urged by urging force F2 of an unillustrated spring member toward the arrow direction of FIG. 5. When the engaging/disengaging member 24 is in engagement with the stopper 23, the door body 10 may be in a latched state in which opening thereof is not possible (see FIG. 5). The door body 10 may enter an unlatched state in which opening thereof is possible (see FIG. 6) when the engaging/disengaging member 24 is made to pivot to reach a position at which the engaging/disengaging member 24 is separated from the stopper 23.

A relationship between the door body unlatching device 15 and the latch mechanism 20 may be as follows. The operating member 9 may have its driving end 9b facing an upper end of the engaging/disengaging member 24. The manual unlatching lever 5 may be connected to a lower end of the engaging/disengaging member 24 via a flexible wire 8. When an ON signal A energizes the solenoid 6 and the plunger 6a jumps out, the operating member 9 pressed by the plunger 6a may pivot counterclockwise in the illustration of FIG. 5, whereby the driving end 9b of the operating member 9 may press the engaging/disengaging member 24 and may make the same pivot clockwise in the illustration of FIG. 5. Then, the lower end of the engaging/disengaging member 24 may be separated from the stopper 23 and a wire 8 i may be s loosened as illustrated in FIG. 6. This allows unlatching of the door body 10 without the need of operating the manual unlatching lever 5. When the operating member 9 pivots counterclockwise in the illustration of FIG. 5, the retractable handle 3 may push a lid member 12 upward projects outward (rearward) through a slit 11 of the door body 10. This allows a user to open the door body 10 by, for example, hooking the fingers on the retractable handle 3.

Also, when the user grasps the manual unlatching lever 5 and raises the same to reach a position indicated by a two-dot chain line in FIG. 6, the lower end of the engaging/disengaging member 24 may be separated from the stopper 23 and the door body 10 may be unlatched. Therefore, the user may open the door body 10 while grasping the manual unlatching lever 5. Note that, in this case, the operating member 9 does not pivot even when the engaging/disengaging member 24 pivots clockwise in the illustration of FIG. 5 but only an upper end of the engaging/disengaging member 24 is separated from the driving end 9b of the operating member 9. Therefore, the retractable handle 3 is still received in the door body 10.

As described above, in the door body unlatching device 15 according to such an embodiment, with the displacement of the operating member 9 pressed by the plunger 6a of the solenoid 6, the door body 10 may be unlatched and the retractable handle 3 may be made to project rearward. Since the operating member 9 is not driven by the manual unlatching lever 5, the retractable handle 3 is still received in the door body 10 when the user manually operates the manual unlatching lever 5 to unlatch the door body 10. That is, when the user has manually unlatched the door body 10, the user may open the door body 10 while still grasping the manual unlatching lever 5. In that case, making the retractable handle 3 project is not important. A configuration in which the retractable handle 3 is made to project only when necessary, as in the present embodiment does not give the user a sense of incongruity.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A door body unlatching device for a vehicle comprising, in a vehicle rear end at which a door body, including a rear door or a trunk lid, is capable of being latched by a latch mechanism:
a human approach sensor configured to detect approaching of a human body;
a retractable handle configured to be capable of being received in the door body and projecting rearward; and
a driver configured to apply driving force to the latch mechanism and the retractable handle,
wherein, when a predetermined signal is output from the human approach sensor, the driver makes the latch mechanism enter an unlatched state, and makes the retractable handle project rearward of the door body.

2. The door body unlatching device for a vehicle according to claim 1, wherein:
one of the human approach sensors is disposed at a right side and the other is disposed at a left side of the vehicle rear end; and
the driver drives the latch mechanism and the retractable handle in accordance with detection signals output from these two human approach sensors.

3. The door body unlatching device for a vehicle according to claim 2, wherein the driver drives the latch mechanism and the retractable handle in accordance with detection signals output a plurality of times from one of the two human approach sensors and a detection signal output once from the other of the two human approach sensors.

4. The door body unlatching device for a vehicle according to claim 3, wherein the human approach sensor is configured to detect approaching of a human body in accordance with a change in a capacitance value.
